(19) United States
(12) Patent Application Publication
(10) Pub. No.: US 2002/0120712 A1
(43) Pub. Date: Aug. 29, 2002

(54) Providing information to a user based on the user's search patterns

(76) Inventor: Seth Maislin, Arlington, MA (US)

Correspondence Address: DAVID L. FEIGENBAUM, Fish & Richardson P.C., 225 Franklin Street, Boston, MA, 02110-2804, US

(21) Appl. No.: 09/794,649

(22) Filed: Feb. 27, 2001

(51) Int. Cl. G06F 15/16

(52) U.S. Cl. 709/217; 709/201

(57) ABSTRACT

Providing information to a user based on the user's search patterns includes identifying a relationship between a first subject and a second subject, receiving, from the user, a search term for searching through the World Wide Web, determining if the search term relates to the first subject, and providing information to the user that relates to the second subject if the search term relates to the first subject.

### BACKGROUND

This invention relates to monitoring a user's search patterns when searching through a database, such as the World Wide Web (“Web”), and providing information to the user based on those search patterns.

A search engine is Web-enabled software that receives search terms from a user and identifies documents on the Web that contain, or are otherwise associated with, those search terms. The documents are typically identified by uniform resource locators (“URLs”), which contain hyperlinks to their full text.

### SUMMARY

In general, in one aspect, the invention features identifying a relationship between a first subject and a second subject, receiving, from a user, a search term for searching through the World Wide Web, determining if the search term relates to the first subject, and providing information to the user that relates to the second subject if the search term relates to the first subject. This aspect may include one or more of the following features.

The first subject includes a set of keywords and the search term includes a keyword. Determining if the search term relates to the first subject includes comparing the keyword from the search term to the keywords in the set of keywords for the first subject. It is determined that the search term relates to the first subject if the keyword from the search term matches a keyword in the set of keywords for the first subject.

The relationship between the first and second subjects is a correlation between the subjects. The correlation is identified by receiving search terms from plural users and identifying that users who input search terms relating to the first subject are likely to input search terms relating to the second subject. A predetermined number of search terms are used to identify that users who input search terms relating to the first subject are likely to input search terms relating to the second subject.

In general, in another aspect, the invention features monitoring a first user's database queries, identifying a relationship between the first user's database queries and a second user's database queries, and providing the first user with information that relates to the second user in response to identifying that relationship. This aspect may include one or more of the following features.

The information is an electronic mail address for the second user. The information indicates that a potential match exists between the first user and the second user. The database is the World Wide Web and the database queries of the first and second user include one or more search terms for searching for information on the World Wide Web. The second user is provided with information in response to identifying the relationship between database queries. The information relates to the first user and may include, e.g., an electronic mail address for the first user.

In general, in another aspect, the invention features receiving a database query from a user, identifying a relationship between the database query and previous database queries from the user, and providing information to the user that is based on the relationship between the database query and the previous database queries. This aspect may include one or more of the following features.

The database includes the World Wide Web and the database queries include search terms for searching for information on the World Wide Web. The information includes World Wide Web content. The previous database queries are received within a predetermined time and stored in memory. A predetermined number of the previous database queries are received and stored. The relationship indicates that the database query and the previous database queries relate to substantially the same subject matter.

Other features and advantages of the invention will become apparent from the following description, including the claims and drawings.

### BRIEF DESCRIPTION OF THE DRAWINGS

FIG. 1 is a view of a computer network.

FIG. 2 is a flowchart showing a process for providing information based on a user's search patterns.

FIG. 3 is a flowchart showing a process for building communities based on a user's search patterns.

FIG. 4 is a flowchart showing a process for disambiguating search terms based on a user's search patterns.

### DESCRIPTION

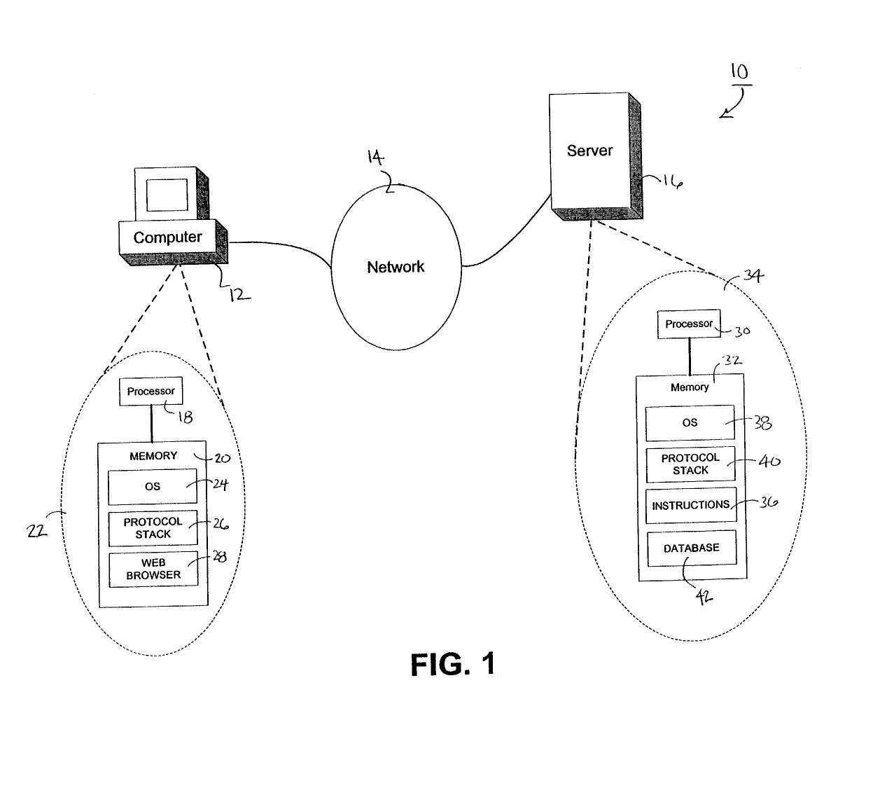

FIG. 1 shows a system 10. System 10 includes a computer 12, such as a personal computer (PC). Computer 12 is connected to a network 14, such as the Internet, that runs TCP/IP (Transmission Control Protocol/Internet Protocol) or another suitable protocol. Connections may be via Ethernet, wireless link, telephone line, or the like. Network 14 contains a server 16, which may be a mainframe computer, a PC, or any other type of processing device.

Computer 12 contains a processor 18 and a memory 20 (see view 22). Memory 20 stores an operating system (“OS”) 24 such as Windows98®, a TCP/IP protocol stack 26 for communicating over network 14, and a Web browser 28 such as Internet Explorer® or Netscape Navigator®, for accessing Web sites and pages hosted by devices on network 14.

Server 16 contains a processor 30 and a memory 32 (see view 34). Memory 32 stores machine-executable instructions 36, OS 38, TCP/IP protocol stack 40, and database 42 relating to users' Web searches. Database 42 is described below. Instructions 36 may be part of an Internet search engine or not, and are executed by processor 30 to perform processes 44, 46 and 48 below. That is, a user at computer 12 uses Web browser 28 to access server 16, which, in response, executes instructions 36 to perform the processes described below.

### Providing Content

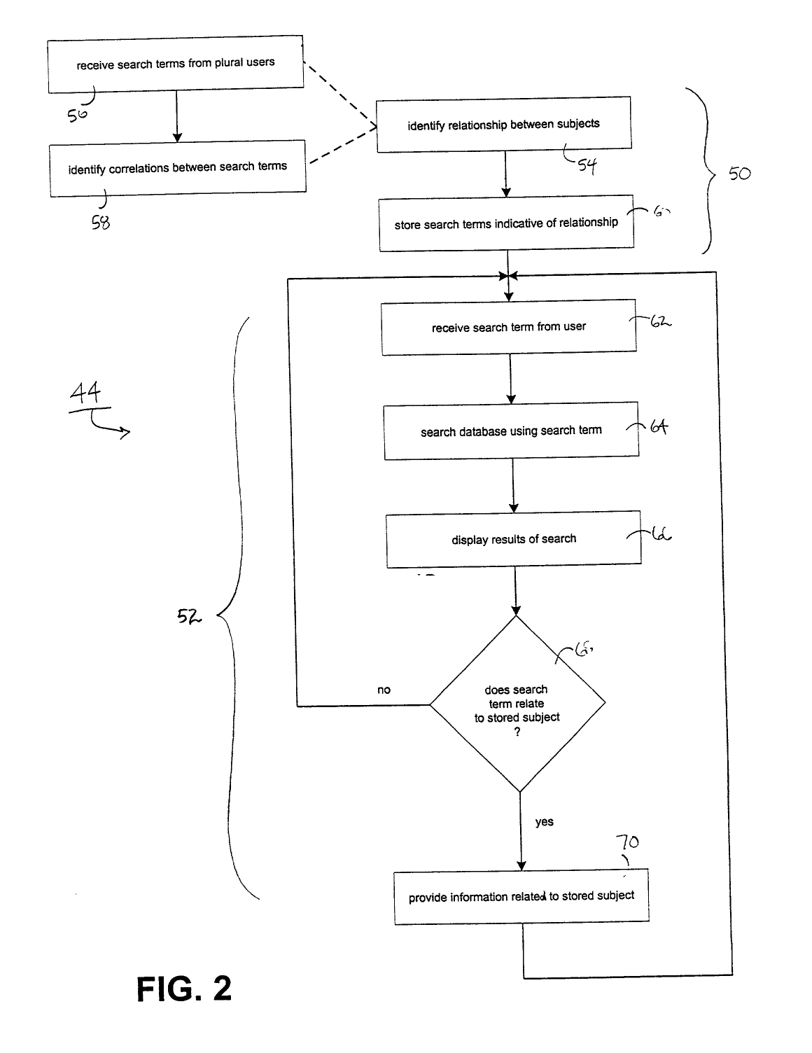

Referring to FIG. 2, a process 44 is shown for providing useful information, such as Web content, to a user based on the user's previous search patterns. Process 44 includes a pre-processing phase 50 and a run-time phase 52. During pre-processing phase 50, process 44 identifies (54) relationships between various subjects. This may be done by receiving (56) search terms from various users and identifying (58) correlations between those search terms. In this context, a “search term” is a phrase containing one or more keywords for searching the Web. Identifying relationships depends, in part, on knowing the identity of the users. The identity of a user may be determined, e.g., by the users logging into a service that implements process 44, by the users' network address, by storing search history information on computer 12, or by any other means.

To obtain the correlation, process 44 recognizes that users who input Web search terms, or other types of “database queries”, relating to one subject have a tendency to input other Web search terms relating to another subject. For example, process 44 may recognize that users who input real estate related terms, such as “real estate”, mortgage, “relocation”, “homes”, etc., also tend to input home decorating related terms, such as “furniture”, “painting”, “interior decorating”, etc. Generally speaking, this correlation exists because people who are relocating and/or purchasing new homes tend to need decorating assistance and supplies.

Correlations between various subjects may be determined “on-the-fly” by process 44, e.g., by keeping track of numbers of users who input related search terms over time. When process 44 determines that a statistically-relevant percentage (e.g., 50%) of users who input terms relating to one subject also input terms relating to another subject, process 44 stores data indicating the correlation in database 42. When determining correlations, some search terms may be weighted more heavily than others. For example, search terms that are more commonly used, such as celebrities' names, may be given less weight than less common search terms when determining the correlations in users' search patterns.

The correlations may also be determined beforehand, i.e., offline, and stored in database 42. That is, database 42 may be constructed to contain correlations between various terms, such as those noted above.

However it is constructed, database 42 contains keywords that define Web search terms. Process 44 stores (60) these keywords in database 42 during pre-processing phase 50 for use during run-time phase 52.

During run-time phase 52, process 44 receives (62) a search term from the user. This search term may be a single keyword or a phrase containing multiple keywords. The search term may be input via a user interface (not shown), such as a textual or graphical interface, that is generated by process 44 and displayed to the user, e.g., on computer 12 via Web browser 28. Alternatively, the search term may be input other than through an interface.

Process 44 searches (64) the Web for information that relates to the search term. For example, if the search term is “real estate Boston”, process 44 searches the Web for information, such as Web pages, relating to real estate in Boston, real estate, and Boston. Process 44 displays (66) the resulting information to the user on computer 12.

Process 44 determines (68) if the received search term relates to a subject stored in database 42. Process 44 does this by comparing keyword(s) from the search term to keyword(s) associated with subjects stored in database 42.

If the keyword(s) from the search term match keyword(s) in database 42, process 44 recognizes that the subject of the search term correlates to another subject. Thus, for the example given above, if the search term includes the keywords “apartments”, and those keywords are also found in database 42 as associated with the subject “real estate”, process 44 determines, from database 42, that the user is interested in the subject “real estate”. The database may contain look-up tables (“LUTs”), which map out the relationships between various keywords, search terms, and/or subjects in database 42.

Process 44 uses the LUTs to obtain keywords for “correlating” subjects from database 42. Once process 44 obtains the keywords from database 42, process 44 uses these keywords to provide (70) Web-related content or other information to the user, along with their search results. For example, process 44 may perform a search of the Web using the keywords and provide URLs to the user that relate to the correlating subject. Process 44 may use the keywords to retrieve advertising from the Web, or any other source, that relates to the correlating subject.

Basically, any type of information that relates to the correlating subject may be provided.

### Building Communities

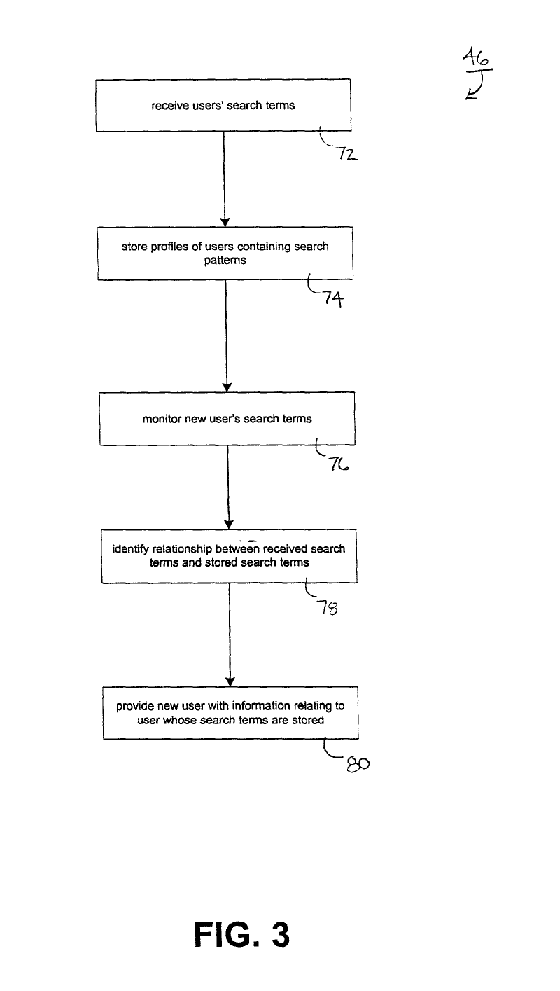

Referring to FIG. 3, a process 46 is shown for building communities based on users' search patterns. Generally speaking, process 46 keeps track of the search patterns of identifiable users, determines if the search patterns of two or more users are similar, and provides information to one or more of the users that could enable the users to connect in some way. Process 46 may be implemented using any database and database queries; however, for illustration's sake, process 46 is described in a Web context using Web search terms.

Process 46 receives (72) search terms from users. The users input the search terms via an interface (not shown) that is generated by instructions 36. Process 46 stores (74) the search terms of the users in memory, e.g., in database 42. The search terms are stored in association with the identity of the user and/or contact information for the user, such as the user's electronic mail (“e-mail”) address, telephone number, and/or mailing address. A user's identity may be stored as a temporary identifier (“ID”) that is obtained by registering with process 46 or another host system. The user may provide any contact information during this registration.

A user's search patterns are monitored over time in order to create a profile of the user. The profile is stored (74) in database 42. The profile may contain, e.g., search terms that the user has input a predetermined number of times or within a predetermined time period. A predetermined number of search terms may be stored for a user, before expiring. Alternatively, the search terms of a user may be stored for only a predetermined period of time, e.g., one month, or they may be stored indefinitely, as long as the user remains registered.

When a new user registers with the system, process 46 monitors (76) the search patterns of the new user. Process 46 does this by keeping track, e.g., storing, the search terms that the user enters into the system. The search terms may be monitored over a predetermined period of time in order to determine which terms are used repeatedly. The frequency of use necessary to constitute a search pattern may be set beforehand in instructions 36. For example, a pattern may be detected if a user inputs a predetermined number search terms over time (e.g., fifty search queries total) or a predetermined number of input actions in a predetermined time frame (e.g., fifty search queries in a month).

Once process 46 identifies a search pattern, process 46 determines if there is a relationship between the search patterns of the new user and the search patterns of other users on the system. Process 46 identifies (78) such relationships by comparing search terms or individual keywords from the new user's search pattern to those of the other users' search patterns. If a predetermined percentage of the search terms of the new user match the search terms of another user, process 46 identifies a match between the two users. The percentage required for a match may be anything, such as 30%, 50% or 70%, and is set beforehand in instructions 36.

When process 46 determines that there is a match between two users, process 46 provides (80) one or both users with information relating to the other user. For example, process 46 may indicate to the new user that the new user's search patterns match the search patterns of another user. Process 46 may provide contact information for the other user as well, such as the other user's e-mail address or telephone number. Privacy considerations, however, may limit the amount of contact information that is provided. The other user may also be provided with similar information about the new user.

### Disambiguating Search Terms

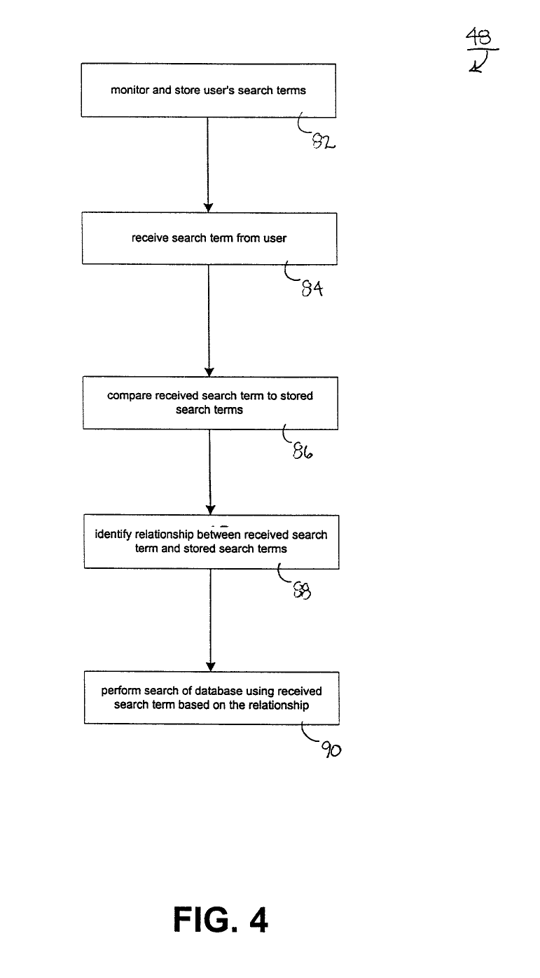

Referring to FIG. 4, a process 48 is shown for disambiguating search terms based on a user's prior search patterns. In this regard, search terms are considered ambiguous if they can relate to more than one subject. For example, the term “Boston” might relate to the city or to the musical group. Process 48 relies on the user's previous search patterns to reduce the ambiguity.

Process 48 monitors (82) a user's search pattern. Process 48 does this by storing the search terms that the user inputs over a predetermined period of time, such as an hour, a month, or whatever time is desired. An unlimited number of search terms may be stored at any one time or storage may be limited to a predetermined number of search terms. The search terms may be stored with time stamps or other indications of when searches were performed using those search terms and with an ID that identifies the user. The identifier may be assigned at registration of the user, as described above. Process 48 determines the user's search patterns based on these search terms.

In more detail, process 48 determines correlations between the user's search terms. Only, in this case (unlike in process 44), process 48 uses the correlations to disambiguate current queries. The correlations are determined in the same manner as above. That is, process 48 identifies search terms that the user has previously used in order to correlate those terms to other terms. In this process, no specific frequency of use is required to obtain a correlation. For example, a user searching for information about the city of Boston might input terms such as “Boston”, “Red Sox”, and “Harvard University”. This single search session can be sufficient to establish a correlation between the search terms.

Process 48 receives (84) a Web search term, or any other database query, from a user and compares (86) the search term to stored search terms that the user has previously entered. Process 48 is thus able to identify (88) any relationship between the input search term and the previous search terms. That is, process 48 determines if a received search term is present in the stored search terms and if the received search term correlates to other search terms in the database. If so, process 48 performs (90) a search of the Web and retrieves URLs of documents that relate to the stored search terms. Documents that do not relate to the stored search terms are either not retrieved or are presented last on the list of documents. In this regard, certain terms are previously correlated, e.g., by an editor or the like. Terms such as “Harvard” and “Boston” may be correlated in a database beforehand. This database is independent of search behavior and can be constructed over time. Thus, when a user types “Harvard” followed by “Boston”, process 48 assumes that the documents being retrieved relate to the city of Boston.

Returning to the foregoing example, assume that a user searches for information relating to the city of Boston. The user's search patterns indicates a propensity to look for information relating to the city of “Boston”. Process 48 compares the user's input search terms to the stored search terms and determines, based on the user's past searches, that the user is looking for information related to the city of Boston and not for information relating to the musical group Boston. Accordingly, process 48 provides a list of URLs to the user that relate to the city of Boston. URLs relating to the band Boston need not be provided, or they may be provided at the end of the list.

### Architecture

Processes 44, 46 and 48 are not limited to use with the hardware/software configuration of FIG. 1; they may find applicability in any computing or processing environment. Processes 44, 46 and 48 may be implemented in hardware (e.g., an ASIC {Application-Specific Integrated Circuit} and/or an FPGA {field Programmable Gate Array}), software, or a combination of hardware and software.

Processes 44, 46 and 48 may be implemented using one or more computer programs executing on programmable computers that each includes a processor, a storage medium readable by the processor (including volatile and non-volatile memory and/or storage elements), at least one input device, and one or more output devices.

Each such program may be implemented in a high level procedural or object-oriented programming language to communicate with a computer system. Also, the programs can be implemented in assembly or machine language. The language may be a compiled or an interpreted language.

Each computer program may be stored on a storage medium or device (e.g., CD-ROM, hard disk, or magnetic diskette) that is readable by a general or special purpose programmable computer for configuring and operating the computer when the storage medium or device is read by the computer to perform processes 44, 46 and 48.

Processes 44, 46 and 48 may also be implemented as a computer-readable storage medium, configured with a computer program, where, upon execution, instructions in the computer program cause the computer to operate in accordance with processes 44, 46 and 48.

In any of processes 44, 46 and 48, predetermined, e.g., offensive or sexually-explicit, content may be identified and not provided to the user. Any aspects of processes 44, 46 and 48 may be combined to form a new process not explicitly described herein. The invention is not limited to the order of processing shown in FIGS. 2, 3 and 4. The blocks of those FIGS. may be rearranged, where appropriate, to perform the functions described herein.

Other embodiments not described herein are also within the scope of the following claims.

What is claimed is:

1. A computer-implemented method comprising:
identifying a relationship between a first subject and a second subject;
receiving, from a user, a search term for searching through the World Wide Web;
determining if the search term relates to the first subject; and
providing information to the user that relates to the second subject if the search term relates to the first subject.

2. The method of claim 1, wherein:
the first subject comprises a set of keywords and the search term includes a keyword; and
determining comprises comparing the keyword from the search term to the keywords in the set of keywords for the first subject.

3. The method of claim 2, wherein it is determined that the search term relates to the first subject if the keyword from the search term matches a keyword in the set of keywords for the first subject.

4. The method of claim 1, wherein the relationship comprises a correlation between the first and second subjects.

5. The method of claim 4, wherein the correlation is identified by:
receiving search terms from plural users; and
identifying that users who input search terms relating to the first subject are likely to input search terms relating to the second subject.

6. The method of claim 5, wherein a predetermined number of search terms are used to identify that users who input search terms relating to the first subject are likely to input search terms relating to the second subject.

7. A computer-implemented method comprising:
monitoring a first user's database queries;
identifying a relationship between the first user's database queries and a second user's database queries; and
providing the first user with information that relates to the second user in response to identifying the relationship.

8. The method of claim 7, wherein the information comprises an electronic mail address for the second user.

9. The method of claim 7, wherein the information indicates that a potential match exists between the first user and the second user.

10. The method of claim 7, wherein the database comprises the World Wide Web and the database queries of the first and second user comprises one or more search terms for searching for information on the World Wide Web.

11. The method of claim 7, further comprising:
providing the second user with information in response to identifying the relationship.

12. The method of claim 7, wherein the information relates to the first user.

13. The method of claim 12, wherein the information comprises an electronic mail address for the first user.

14. A computer-implemented method, comprising:
receiving a database query from a user;
identifying a relationship between the database query and previous database queries from the user; and
providing information to the user that is based on the relationship between the database query and the previous database queries.

15. The method of claim 14, wherein the database comprises the World Wide Web and the database queries comprise search terms for searching for information on the World Wide Web.

16. The method of claim 14, wherein the information comprises World Wide Web content.

17. The method of claim 14, further comprising:
receiving the previous database queries within a predetermined time; and
storing the previous database queries in memory.

18. The method of claim 14, further comprising:
receiving a predetermined number of the previous database queries; and
storing the previous database queries in memory.

19. The method of claim 14, wherein the relationship indicates that the database query and the previous database queries relate to substantially the same subject matter.

20. A computer program stored on a computer-readable medium, the computer program comprising instructions that cause a computer to:
identify a relationship between a first subject and a second subject;
receive, from a user, a search term for searching through the World Wide Web;
determine if the search term relates to the first subject; and
provide information to the user that relates to the second subject if the search term relates to the first subject.

21. The computer program of claim 20, wherein:
the first subject comprises a set of keywords and the search term includes a keyword; and
determining comprises comparing the keyword from the search term to the keywords in the set of keywords for the first subject.

22. The computer program of claim 21, wherein it is determined that the search term relates to the first subject if the keyword from the search term matches a keyword in the set of keywords for the first subject.

23. The computer program of claim 20, wherein the relationship comprises a correlation between the first and second subjects.

24. The computer program of claim 23, wherein the correlation is identified by:
receiving search terms from plural users; and
identifying that users who input search terms relating to the first subject are likely to input search terms relating to the second subject.

25. The computer program of claim 24, wherein a predetermined number of search terms are used to identify that users who input search terms relating to the first subject are likely to input search terms relating to the second subject.

26. A computer program stored on a computer-readable medium, the computer program comprising instructions that cause the computer to:
monitor a first user's database queries;
identify a relationship between the first user's database queries and a second user's database queries; and
provide the first user with information that relates to the second user in response to identifying the relationship.

27. The computer program of claim 26, wherein the information comprises an electronic mail address for the second user.

28. The computer program of claim 26, wherein the information indicates that a potential match exists between the first user and the second user.

29. The computer program of claim 26, wherein the database comprises the World Wide Web and the database queries of the first and second user comprises one or more search terms for searching for information on the World Wide Web.

30. The computer program of claim 26, further comprising instructions that cause the computer to:
provide the second user with information in response to identifying the relationship.

31. The computer program of claim 26, wherein the information relates to the first user.

32. The computer program of claim 31, wherein the information comprises an electronic mail address for the first user.

33. A computer program stored on a computer-readable medium comprising instructions that cause a computer to:
receive a database query from a user;
identify a relationship between the database query and previous database queries from the user; and
provide information to the user that is based on the relationship between the database query and the previous database queries.

34. The computer program of claim 33, wherein the database comprises the World Wide Web and the database queries comprise search terms for searching for information on the World Wide Web.

35. The computer program of claim 33, wherein the information comprises World Wide Web content.

36. The computer program of claim 33, further comprising instructions that cause the computer to:
receive the previous database queries within a predetermined time; and
store the previous database queries in memory.

37. The computer program of claim 33, further comprising instructions that cause the computer to:
receive a predetermined number of the previous database queries; and
store the previous database queries in memory.

38. The computer program of claim 33, wherein the relationship indicates that the database query and the previous database queries relate to substantially the same subject matter.

39. An apparatus comprising:
a memory that stores executable instructions; and
a processor that executes the instructions to:
identify a relationship between a first subject and a second subject;
receive, from a user, a search term for searching through the World Wide Web;
determine if the search term relates to the first subject; and
provide information to the user that relates to the second subject if the search term relates to the first subject.

40. The apparatus of claim 39, wherein:
the first subject comprises a set of keywords and the search term includes a keyword; and
determining comprises comparing the keyword from the search term to the keywords in the set of keywords for the first subject.

41. The apparatus of claim 40, wherein it is determined that the search term relates to the first subject if the keyword from the search term matches a keyword in the set of keywords for the first subject.

42. The apparatus of claim 39, wherein the relationship comprises a correlation between the first and second subjects.

43. The apparatus of claim 42, wherein the correlation is identified by:
receiving search terms from plural users; and
identifying that users who input search terms relating to the first subject are likely to input search terms relating to the second subject.

44. The apparatus of claim 43, wherein a predetermined number of search terms are used to identify that users who input search terms relating to the first subject are likely to input search terms relating to the second subject.

45. An apparatus comprising:
a memory that stores executable instructions; and
a processor that executes the instructions to:
monitor a first user's database queries;
identify a relationship between the first user's database queries and a second user's database queries; and
provide the first user with information that relates to the second user in response to identifying the relationship.

46. The apparatus of claim 45, wherein the information comprises an electronic mail address for the second user.

47. The apparatus of claim 45, wherein the information indicates that a potential match exists between the first user and the second user.

48. The apparatus of claim 45, wherein the database comprises the World Wide Web and the database queries of the first and second user comprises one or more search terms for searching for information on the World Wide Web.

49. The apparatus of claim 45, wherein the processor executes instructions to:
provide the second user with information in response to identifying the relationship.

50. The apparatus of claim 45, wherein the information relates to the first user.

51. The apparatus of claim 50, wherein the information comprises an electronic mail address for the first user.

52. An apparatus comprising:
a memory that stores executable instructions; and
a processor that executes the instructions to:
receive a database query from a user;
identify a relationship between the database query and previous database queries from the user; and
provide information to the user that is based on the relationship between the database query and the previous database queries.

53. The apparatus of claim 52, wherein the database comprises the World Wide Web and the database queries comprise search terms for searching for information on the World Wide Web.

54. The apparatus of claim 52, wherein the information comprises World Wide Web content.

55. The apparatus of claim 52, wherein the processor executes instructions to:
receive the previous database queries within a predetermined time; and
store the previous database queries in memory.

56. The apparatus of claim 52, wherein the processor executes instructions to:
receive a predetermined number of the previous database queries; and
store the previous database queries in memory.

57. The apparatus of claim 52, wherein the relationship indicates that the database query and the previous database queries relate to substantially the same subject matter.
